(19) United States
(12) Patent Application Publication
(10) Pub. No.: US 2004/0073926 A1
(43) Pub. Date: Apr. 15, 2004

(54) Digital broadcast reception apparatus

(75) Inventors: Hideki Nakamura, Hyogo (JP); Mitsuru Sasaki, Hyogo (JP); Yasuo Nakashima, Hyogo (JP); Hideshi Nishizawa, Hyogo (JP); Masahiro Kamiya, Hyogo (JP); Masahiko Kitagawa, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 10/678,214

(22) Filed: Oct. 6, 2003

(30) Foreign Application Priority Data
Oct. 11, 2002 (JP) 2002-299285

(51) Int. Cl. H04N 5/445; G06F 13/00; G06F 3/00

(52) U.S. Cl. 725/53; 725/45

(57) ABSTRACT

A digital broadcast reception apparatus has a program search function of receiving a digital broadcast containing program guide information while changing the frequency received in a tuner. The program guide information is selected using a condition input through a remote control as a search condition, and the genre or service type is narrowed down for temporary presentation of a program from a loudspeaker or on a display. If the audience selects the program, reception of the program is continued. As a result of trial reception, the program search can also be further continued.

The present disclosure relates to the subject matter contained in Japanese Patent Application No.2002-299285 filed on Oct. 11, 2002, which is incorporated herein by reference in its entirety.

### BACKGROUND OF THE INVENTION

1. Field of the Invention

The invention relates to a digital broadcast reception apparatus.

2. Description of the Related Art

In Japan, digitalization of television (TV) broadcasts and radio broadcasts will be started in 2003 in order. Hitherto, BS (Broadcasting Satellite) digital broadcasts from broadcasting satellites and CS (Communication Satellite) digital broadcasts from communication satellites have been carried out as satellite digital broadcasts using artificial satellites in geostationary orbits. As multiple channels are provided accompanying digitalization of the broadcasts, it is made possible for the audience to receive various broadcasts, but it becomes difficult to discriminate information (programs), which he/she desires to watch, accordingly.

The digital broadcast contains an EPG (Electronic Program Guide) function for audience's convenience in discriminating a broadcast program. That is, the EPG is a service provided by broadcast stations to aid the audience in selection of programs. It becomes possible for the audience to select the program to be received, watched, and recorded with a television screen rather than with a newspaper, a magazine, etc., as a paper program guide.

In Japan, standardization work for the digital broadcasts is advanced in Association of Radio Industrial Business (ARIB), and the technique of ISO (International Standards Organization) 13818 called MPEG2 of color moving picture compression techniques internationally defined by MPEG (Moving Picture Experts Group) is adopted. In MPEG2, coded video and audio are put into a packet and the packet is transmitted in the TS (Transport Stream) format of a fixed length fitted for transmission.

The EPG function is realized on the basis of text information transmitted by program arrangement information SI (Service Information) contained in MPEG-TS signal. The text information EPG contains a program guide and program guide information. The program guide contains the start time, duration, program name, and genre. The program guide information contains the cast, writer, and keyword. Service for providing such text information EPG is already started in CS digital broadcasts. EPG, called multimedia information EPG, is also defined based on a document description language called BML (Broadcast Markup Language) used to describe data broadcast with the MPEG-TS signal.

In digital broadcasts of DAB (Digital Audio Broadcasting), which is actually conducted in Europe, a signal is provided in frame units and a transmission frame is made up of three channels. One of the channels is a fast information channel (FIC) containing information of multiple configuration information and service classification information. The information also contains information about alternate broadcasts and an art has also been proposed for realizing an auto scan function of checking the service contents from a plurality of digital broadcasts in order by receiving alternate broadcasts from the information about alternate broadcasts obtained upon reception of digital broadcasts and checking the service contents (See JP-A-2000-124823).

The EPG function provided in digital broadcasts provides the program guide and the program guide information in a listing manner. However, on an EPG screen in the listing manner, the program information, which can be displayed, is limited and the audience cannot instantaneously obtain detailed information. In screen operation to obtain detailed information, the audience must perform a button operation frequently and the operation becomes intricate. Particularly, in a vehicle-installed digital broadcast reception apparatus, the display screen becomes small and thus EPG screen operation is not effective as means for searching for the program, which the audience desires to watch.

In analog TV broadcasts and analog digital broadcasts, a channel search function is available; the function is to automatically present a receivable program (video or audio) to the audience for a given time for the audience to find any desired program. This technique is also effective with a digital broadcast reception apparatus. The related art for receiving alternate broadcasts and presenting receivable programs has also been proposed as described above. However, in digital broadcasts, video, audio, and data are multiplexed and provided from one broadcast station and the number of provided service types is also large. Thus, if the programs are received to check the service contents in order, there is also a possibility that it will take time until any desired program is reached.

### SUMMARY OF THE INVENTION

It is an object of the invention to provide a digital broadcast reception apparatus for making it possible to make an efficient program search.

According to embodiments of the invention, a digital broadcast reception apparatus receives a digital broadcast including a program and program guide information for providing a guide to the program content. The digital broadcast reception apparatus includes a broadcast reception unit for receiving a digital broadcast on air, a condition determination unit for determining whether or not the program matches a search condition on the basis of the program guide information received by the broadcast reception unit, and a program search unit for making a program search by controlling the broadcast reception unit to continue to receive the digital broadcast containing the program, which is determined matching the search condition by the condition determination unit, and to stop receiving the digital broadcast containing the program, which is not determined matching the search condition by the condition determination unit and to receive another digital broadcast.

The digital broadcast reception apparatus receives a digital broadcast of a program and program guide information for providing a guide to the program content. The digital broadcast reception apparatus includes the broadcast reception means, the condition determination means, and the program search means. When the broadcast reception unit receives a digital broadcast on air, the condition determination unit determines whether or not the program to which a guide is provided by the program guide information matches the search condition based on the program guide information received by the broadcast reception unit. The program search unit makes a program search by controlling the broadcast reception unit so as to continue to receive the digital broadcast of the program determined matching the search condition by the condition determination unit and stop receiving the digital broadcast of the program not determined matching the search condition and receive a different digital broadcast. Thus, the received programs can be narrowed down so as to receive only the programs matching the preset search condition rather than all broadcast programs; an efficient program search can be accomplished.

The digital broadcast reception apparatus may further include a condition input unit for accepting an entry operation of a condition, and a condition setting unit for setting the condition input in the condition input unit as the search condition.

According to the embodiments of the invention, the audience can input the search condition used by the condition determination unit for determination in the condition input unit. If the audience inputs the condition, it is set as the search condition by the condition setting unit. Thus, the audience can input a search condition for the program search function as desired and can rapidly find any desired program.

The condition input unit may accept an entry operation of selecting the condition from a previously prepared list including a plurality of conditions. The condition setting unit may set the condition, which is selected by the condition input unit accepting the entry operation, as the search condition.

According to the embodiments of the invention, it is made possible for the audience to select a condition input in the condition input unit from the previously prepared condition list. Thus, the condition entry operation of the audience can be simplified.

A plurality of conditions can be input in the condition input unit. It is possible to specify logical operation of the conditions, for example, at least one or a combination of NOT negating the input condition, OR indicating that the program may meet at least one of the input conditions, and AND requiring that the program should meet all input conditions. If at least one of the operations is specified. If operation is specified for the condition input into the condition input unit, the condition setting unit sets the condition as the search condition used by the condition determination unit for determination with the specified operation performed.

According to the embodiments of the invention, when at least one operation such as negation NOT of the condition input by the audience into the condition input unit or OR or AND on a plurality of conditions is specified, as the search condition used by the condition determination unit for determination, the condition setting unit sets the search condition containing the specified operation. Thus, a program search can be efficiently made under any desired condition of the audience.

The condition input unit may accept an operation of specifying a program genre as the condition.

According to the embodiments of the invention, the program genre can be specified as the condition. Thus, a program search can be made in accordance with the audience's wishes for the genre with the search condition set about the genre.

Service types of the digital broadcast may include video, audio, data, and temporary broadcast. The condition input unit may accept an operation of specifying at least one of the service types as the condition.

According to the embodiments of the invention, the service type of video, audio, data, or temporary contained in digital broadcast can be specified as the condition. Thus, a program search can be made in accordance with the audience's wishes for the service type with the search condition set about the service type.

Service types of the digital broadcast may include video, audio, data, and temporary broadcast. The program search unit may make the program search for each program service.

According to the embodiments of the invention, since a program search is made based on the set condition for each service type of video, audio, data, and extraordinary contained in digital broadcast, if the programs provided by a plurality of services meet the set condition, program selection can be made while a comparison is being made between the service types.

The condition input unit may be input into a keyword concerning at least one of a program name, cast, and program detail information. The condition setting unit may set the search condition to receive a program containing the keyword input into the condition input unit.

According to the embodiments of the invention, a keyword concerning at least one of the program name, cast, and program detail information can be input into the condition input unit. Thus, the audience can input a keyword to select any desired program and can find a program with the input keyword contained in at least any of the program name, cast, or program detail information.

The digital broadcast reception apparatus may further include a request input unit and a control unit. The request input unit allows to input a program trial reception request while the program search unit is executing the program search. The control unit controls the program search unit to stop the program search and controls the broadcast reception unit to execute program trial reception when the program trial reception request is input into the request input unit.

According to the embodiments of the invention, if the user inputs a program trial reception request into the request input unit while the program search unit is executing a program search, the control unit controls the program search unit and the broadcast reception unit so as to stop the program search and execute program trial reception. Thus, the user can try actually receiving the program satisfying the search condition during program search execution.

The request input unit may allow to input a program search restart request for stopping the program trial reception and restarting the program search. When the program search restart request is input into the request input unit, the control unit may control the program search unit to restart the program search at the program search stop state.

According to the embodiments of the invention, if program trial reception is executed during program search execution, the search can be restarted at the search stop state. Thus, a search can be made for new programs without repealing the search for the trial-received program.

The digital broadcast reception apparatus may further include a condition retention unit for retaining the search conditions set by the condition setting unit.

According to the embodiments of the invention, since the search conditions set by the condition setting unit are retained in the condition retention unit, any retained search condition can be used to make a program search or can be changed for making a program search.

The condition determination unit may determine whether or not the program matches the search condition retained in the condition retention unit.

According to the embodiments of the invention, the program search can be made according to the retained search condition. Thus, once the search condition is set, when the program search is made according to the same search condition, rapid program search can be made without setting any search condition at the next time.

### BRIEF DESCRIPTION OF THE DRAWINGS

FIG. 1 is a block diagram to show a schematic electric configuration of a digital broadcast reception apparatus 1 of one embodiment of the invention.

FIG. 2 is a drawing to show an example of a search condition setting screen displayed on the digital broadcast reception apparatus 1 in FIG. 1.

FIG. 3 is a drawing to show an example of a search condition setting screen displayed on the digital broadcast reception apparatus 1 in FIG. 1.

FIG. 4 is a drawing to show a schematic format of an MPEG-TS signal transmitted in a digital broadcast.

FIG. 5 is a drawing to show the contents of a TS transmitted in a digital broadcast.

FIG. 6 is a flowchart to show a program search operation procedure of the digital broadcast receiver in FIG. 1.

FIG. 7 is a flowchart to show a program search operation procedure of the digital broadcast receiver in FIG. 1.

FIG. 8 is a drawing to show screens during the operation in FIG. 7.

FIG. 9 is a drawing to show an example of a search condition setting screen displayed on the digital broadcast reception apparatus 1 in FIG. 1.

### DETAILED DESCRIPTION OF THE PREFERRED EMBODIMENTS

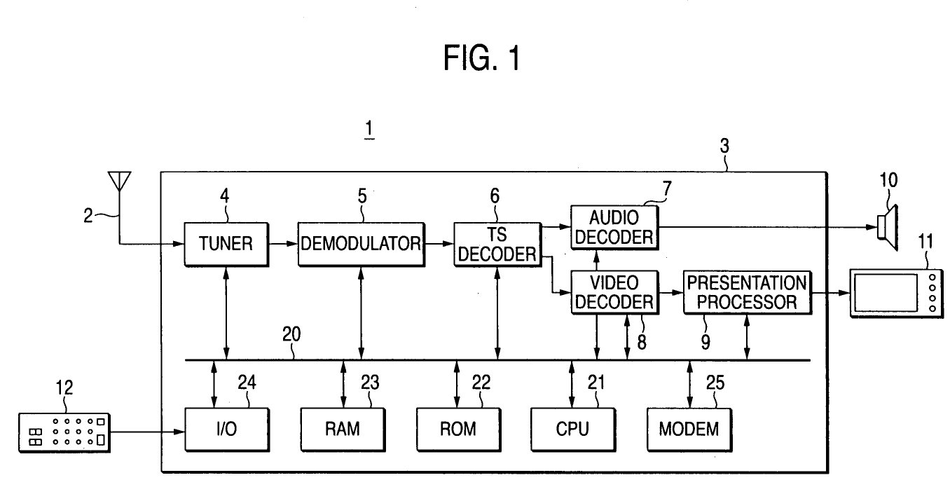

FIG. 1 shows a schematic electric configuration of a digital broadcast reception apparatus 1 according to one embodiment of the invention. The digital broadcast reception apparatus 1 receives radio waves of digital broadcasts at an antenna 2, converts the radio waves into high-frequency electric signals, inputs the high-frequency electric signals to a receiver 3, and extracts each program. The receiver 3 has functional circuits including a tuner 4, a demodulator 5, a TS decoder 6, an audio decoder 7, a video decoder 8, and a presentation processor 9. In a digital broadcast, as MPEG-TS signal, multiplexed information is put into a packet, which is then transmitted as digital form. The tuner 4 amplifies the MPEG-TS signal in high-frequency signal state and converts the signal into a lower frequency. The demodulator 5 demodulates the MPEG-TS signal as a digital signal. The TS decoder 6 separates information multiplexed to the MPEG-TS signal into service types. The audio decoder 7 decodes audio data into acoustic output and plays back sound from a loudspeaker 10. The video decoder 8 decodes video data and the presentation processor 9 performs image processing and the result is displayed on a display 11.

EPG information contained in the MPEG-TS signal enables the audience to select a program by operating a remote control 12 including predetermined functions. If the receiver 3 includes a record function, the user can also program the receiver 3 to record any desired program by operating the remote control 12. A CPU 21 controls the receiver 3 through a system bus 20. The CPU 21 operates in accordance with a program previously stored in ROM 22 and controls the receiver 3 while using RAM 23 as temporary memory of data, etc. The CPU 21 is connected to the remote control 12 through an input/output interface (I/O) 24. A modem 25 is also connected to the system bus 20 and enables the reception apparatus 1 (receiver 3) to connect to an external public switched telephone line, etc.

To add a record function to the receiver 3, a large capacity storage such as a hard disk unit or flash memory may be provided. A VCR (video cassette recorder), an optical disk unit such as a writable DVD (digital versatile disc), or the like can also be used. To install the reception apparatus 1 in a vehicle, it is also made possible to use a touch panel in place of the remote control 12 if the EPG information is converted.

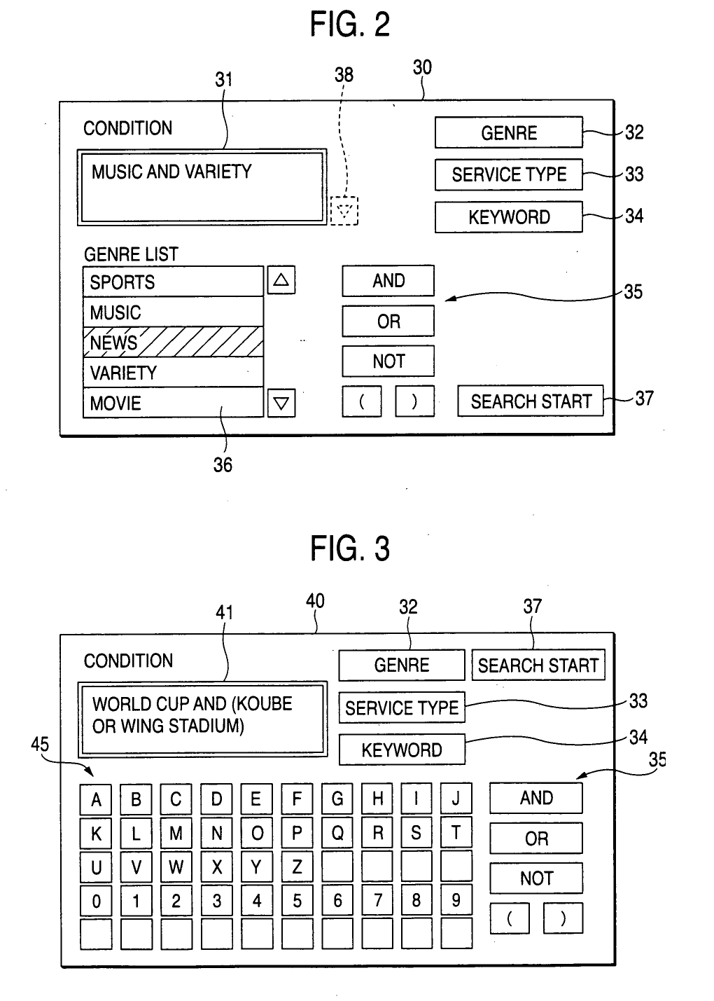

FIG. 2 shows an example of a search condition setting screen 30 displayed on the display 11 in FIG. 1. FIG. 2 shows a state where on the search condition setting screen 30, genre 32 is selected from among genre 32, service type 33, and keyword 34 as a condition 31 and is input with the remote control 12, etc. A plurality of conditions can also be concatenated by specifying “AND”, “OR”, “(”, and “)” contained in operation specification 35. “NOT” can also be specified for a single condition. To specify the genre 32, any desired entry can be selected out of a genre list 36. A similar list is also displayed for the service type 33. In the figure, music and variety are selected out of the genre list 36 and are concatenated by “AND” and therefore a search condition for music variety programs is set. If an operation of specifying a search start 37 is performed with the remote control 12, etc., a search for programs matching the search condition is started.

“AND” contained in the operation specification 35 corresponds to AND operation and specifies that both two conditions should be satisfied. “OR” corresponds to OR operation and specifies that at least either of two conditions should be satisfied. “NOT” specifies negation and is true if the condition with “NOT” is not satisfied. “(” and “)” specify change of priorities. For example, in the condition of A AND B OR C, generally AND takes priority and therefore operation of A AND B is first performed and OR operation for C is performed on the operation result. If “(” and “)” are used as A AND (B OR C), the AND operation for A can be performed on the operation result of B OR C.

If a history of setting conditions is available, an arrow symbol, etc., is displayed as search condition history 38. If an operation of specifying the displayed search condition history 38 is performed with the remote control 12, etc., a search condition history is displayed in list form. With regard to the search condition list, the genre list 36, a service type list, etc., all entries are displayed until a given number of entries, such as five, are reached and when the entries are displayed exceeding the given number, the most recent search condition or a frequently used search condition may be displayed preferentially. A low-order search condition may be displayed by further specifying the arrow, etc.

FIG. 3 shows an example of a search condition setting screen 40 when an operation of specifying the keyword 34 is performed in FIG. 2. Parts identical with those of the search condition setting screen 30 previously described with reference to FIG. 2 are denoted by the same reference numerals in FIG. 3 and will not be discussed again. In condition 41, alphabetical letters displayed in an alphabetical letter list 45 are specified and input one letter at a time and, for example, the keyword 34 is again specified, whereby a character string such as “world cup” or “wing stadium” can be input. It should be noted that the search condition setting screen 40 may be configured to input a keyword in language other than English language. If the user desires to input a keyword in Japanese language, the user may specify a hiragana character or a katakana character one by one and convert the input keyword into kanji characters, if necessary. “AND”, “OR”, “(”, and “)” can be specified in operation specification 35. In the example of the condition 41, the program search condition specifies that at least either Koube or wing stadium should be contained and world cup should be contained.

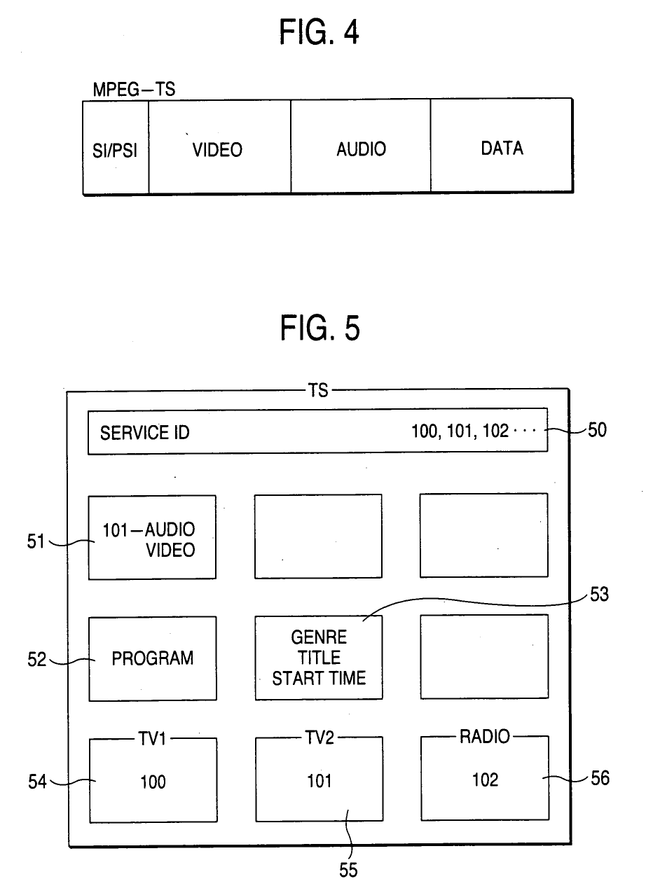

FIG. 4 shows an outline of the MPEG-TS signal transmitted in a digital broadcast. The MPEG-TS signal is transmitted in a constant-length packet in order and a plurality of packets are concatenated containing table information indicating the relationship between a program containing program arrangement information SI, PSI (program specific information), etc., and data forming the program. The data forming the program contains video (VIDEO), audio (AUDIO), and data (DATA). A program search is executed using SI and PSI. Such packets are classified based on identification information contained in each head.

FIG. 5 shows an example of information contained in a TS in a digital broadcast from one broadcast station. The TS contains service ID 50, service information 51, program information 52, program detail information 53, and program data 54, 55, and 56. The service ID 50 indicates that programs indicated by ID numbers 100, 101, 102, . . . , for example, are multiplexed and broadcast. The service information 51 indicates that the service of service ID number 101 is provided in audio and video. The program information 52 lists provided programs. The program detail information 53 indicates detail information of the genre, title, start time, etc., for each program. The program data 54, 55, and 56 provide the data of the programs specified by the ID numbers 100, 101, and 102.

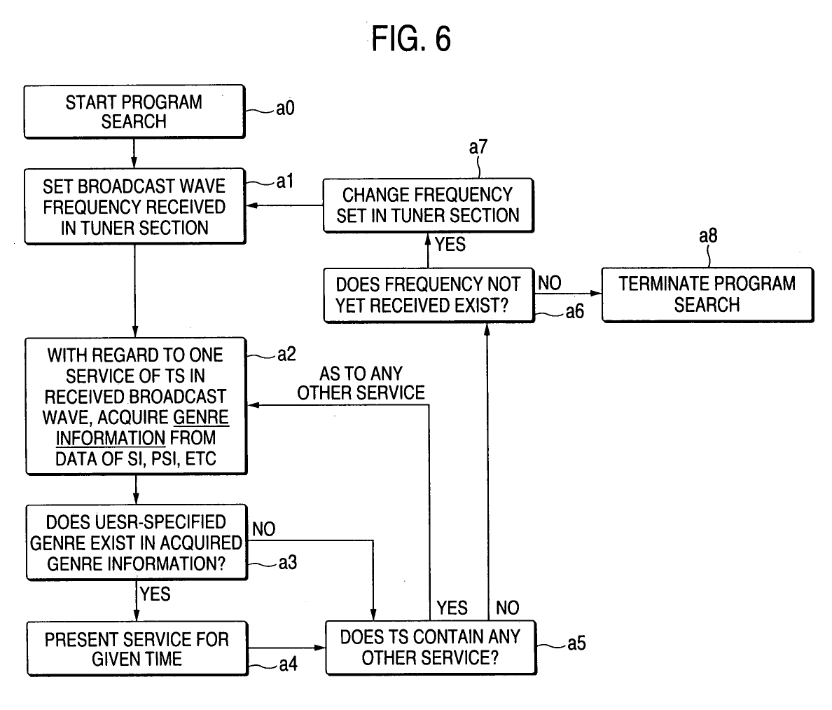

FIG. 6 shows an outline of an execution procedure of a program search executed with the search condition being read from the memory such as the RAM 23 after the search condition set in FIG. 2 or 3 is stored in the memory. A program search is started at step a0. At step a1, the broadcast wave frequency received in the tuner section of the tuner 4 in FIG. 1 is set to the lowest frequency of frequency band, for example. At step a2, for one service of the TS in the received broadcast wave, information to which the search condition is applied, such as genre information, is acquired from the data of SI, PSI, etc. At step a3, whether or not the genre specified by the user (audience) exists in the acquired genre information is determined. If it is determined that the genre exists in the genre information, at step a4, the received service is presented from the loudspeaker 10 or the display 11 for a given time. After the service is presented at step a4 or if it is determined at step a3 that the specified genre does not exist in the genre information, control goes to step a5.

At step a5, whether or not the TS contains any other service is determined. If it is determined that the TS contains any other service, control returns to step a2 and the determination as to the service is repeated. If it is determined at step a5 that the TS does not contain any other service, whether or not frequency not yet received exists is determined at step a6. If it is determined that frequency not yet received exists, the frequency set in the tuner section is changed to higher frequency in order, for example, at step a7 and control returns to step a1. If it is determined at step a6 that frequency not yet received does not exist, the program search is terminated at step a8.

That is, the program search according to the embodiment is made as digital broadcast frequency bands are received while frequencies are changed in order in the tuner 4 and the EPG information contained in the MPEG-TS signal is detected. The digital broadcast reception apparatus 1 is an apparatus, which receives a digital broadcast of a program and program guide information for providing a guide to the program content. The apparatus includes the receiver 3 (a broadcast reception unit) and the CPU 21 (a condition determination unit; a program search unit). The receiver 3 receives a digital broadcast on air. The CPU 21 determines whether or not the program to which a guide is provided by program guide information matches a preset search condition based on the program guide information received by the broadcast reception unit. The CPU 21 makes a program search by controlling the receiver 3 (the broadcast reception unit) so as to continue to receive the digital broadcast of the program, which is determined matching the search condition by the CPU 21 (the condition determination unit), and to stop receiving the digital broadcast of the program, which is not determined matching the search condition and to receive a different digital broadcast.

Upon reception of a digital broadcast on air, whether or not the program to which a guide is provided matches the preset search condition is determined based on the received program guide information. A program search is made so as to continue to receive the digital broadcast of the program, which is determined matching the search condition, and stop receiving the digital broadcast of the program, which is not determined matching the search condition, and receive a different digital broadcast. Thus, the received programs can be narrowed down so as to receive only the programs matching the preset search condition rather than all broadcast programs; an efficient program search can be accomplished.

The remote control 12 shown in FIG. 1 can be used as a condition input unit for accepting an entry operation of a condition as shown in FIG. 2 or 3. The CPU 21 functions as a condition setting unit for setting the input condition as the search condition. The audience can input a search condition and if the audience inputs a condition, it is set as the search condition, so that the audience can input a search condition for the program search function as desired and can rapidly find any program desired to watch.

As shown in FIG. 2, it is also possible to accept an entry of selecting a condition out of a provided condition list and the condition selected through operation of the remote control 12, etc., is set as the search condition, so that the condition entry operation of the audience can be simplified. It is possible to input a plurality of conditions and it is possible to specify logical operation of the conditions, for example, operation on at least one or a combination of NOT negating the input condition, OR indicating that the program may meet at least one of the input conditions, and AND requiring that the program should meet all input conditions. If operation is specified for the input condition, the condition is set as the search condition with the specified operation performed, so that a program search can be efficiently made under any desired condition of the audience.

As the condition, program genre or the service type of video, audio, data, or temporary can be specified, so that a program search can be made in accordance with the audience's desires with the search condition set about the genre or the service type.

A program search can also be made for each service type. For example, for TS acquired at one frequency, a search is made for one service type, for example, TV broadcast and then the frequency is changed and a similar search is made. After a similar search is made for TSs at all frequencies that can be received, again for TS acquired at one frequency, a search is made for a different service type from the previous service type, for example, radio broadcast and then a search is continued until completion of searching for all service types. Since a program search is made based on the set condition for each service type, if the programs provided by a plurality of services meet the set condition, program selection can be made while a comparison is being made between the service types.

It is possible to input a keyword about at least any of the program name, cast, or program detail information and the search condition is set so as to receive a program containing the input keyword, so that the audience can input a keyword to select any desired program and can find a program with the input keyword contained in at least any of the program name, cast, or program detail information.

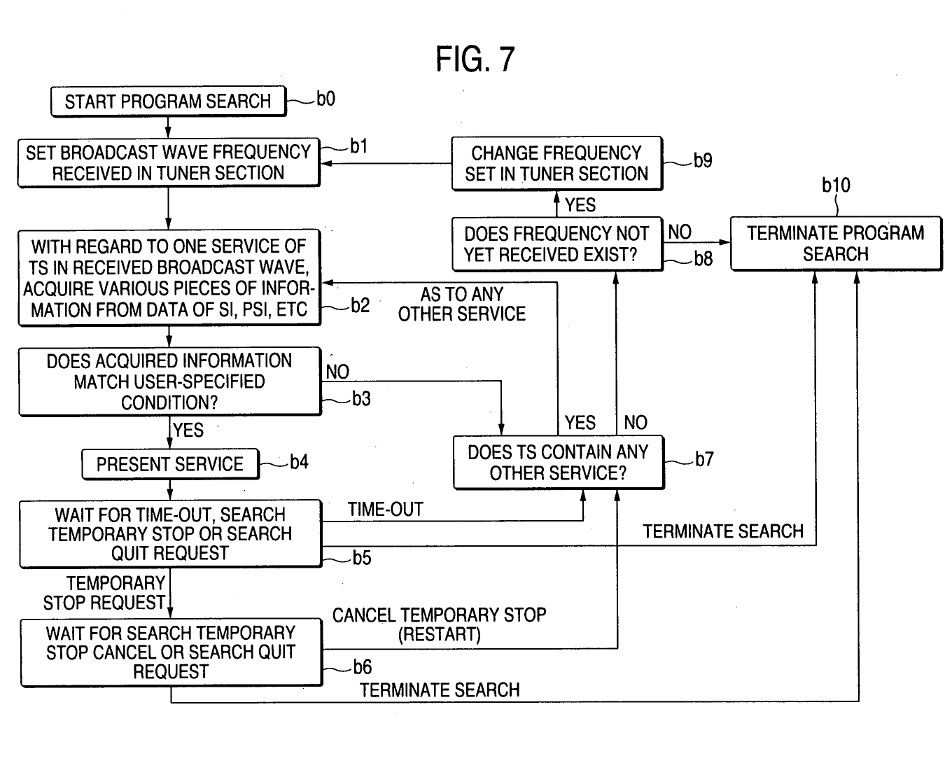

FIG. 7 shows a procedure for enabling the user (audience) to give a search temporary stop command during program searching. When such command is given, the program search is temporarily stopped and the service presented at the time is further presented for a long time. If the user inputs a program search restart command while the program search is temporarily stopped, the program search is restarted at a midpoint in the previous program search sequence. If the user inputs a program search quit command while the program search is being made or is temporarily stopped, the program search is terminated.

That is, the procedure is started at step b0 and steps b0 to b4 are basically similar to steps a0 to a4 in FIG. 6. After service is presented at step b4, a wait is made for a time-out meaning that a given time has elapsed or until the user makes a search temporary stop or search quit request. When the user makes a temporary stop request, control goes to step b6 and it is waited that the user makes a search temporary stop cancel or search quit request. When the user inputs a temporary stop cancel command, control goes to step b7. When a time-out occurs at step bb, control also goes to step b7. At step b7, whether or not the TS contains any other service is determined as with step a5 in FIG. 6. If the TS contains any other service, control returns to step b2. If it is determined at step b7 that the TS does not contain any other service, whether or not frequency not yet received exists is determined at step b8. If it is determined that frequency not yet received exists, the frequency set in the tuner section is changed at step b9 and control returns to step b1. If it is determined at step b8 that frequency not yet received does not exist or if the user makes a search quit request at step b5 or b6, the program search is terminated at step b10.

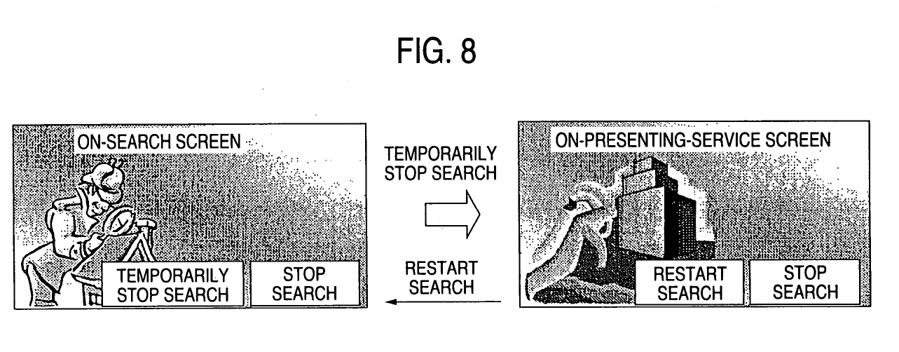

FIG. 8 shows a program searching screen and a service presenting screen. The service presenting screen is presented temporarily at step b4 in FIG. 7 or is presented at step b6.

The CPU 21 in FIG. 1 also functions as a request input unit and a control unit. The request input unit enables the user to input a program trial reception request during execution of a program search. The control unit controls the program search unit to stop the program search and controls the broadcast reception unit to execute program trial reception when the user inputs a program trial reception request. If the user inputs a program trial reception request during execution of a program search, the program search is stopped and program trial reception is executed, so that the user can try actually receiving the program satisfying to search condition during program search execution.

It is also possible to stop program trial reception and restart the program search. When the user inputs a program search restart request, the program search can be restarted at the program search stop state, so that a search can be made for new programs without repeating the search for the trial-received program.

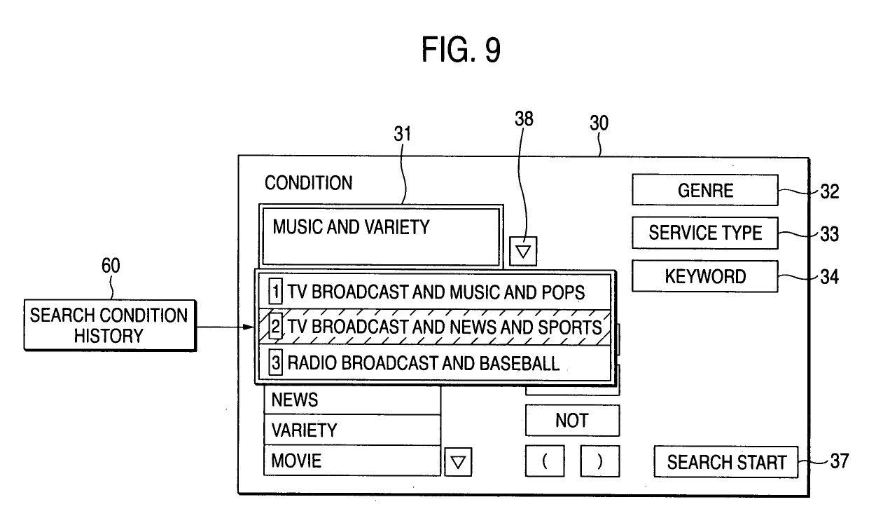

FIG. 9 shows a state in which the search conditions stored as described above are displayed on the search screen 30 in FIG. 2. The search condition history 38 is displayed and when the user specifies the search condition history 38, a search condition history list 60 is displayed. If the user selects one search condition out of the search condition history list 60, the set condition can be specified promptly. To store the search conditions, preferably hard disk or nonvolatile memory such as flash memory is used as a condition retention unit for retaining the search conditions. Since the search conditions are retained in the condition retention unit, any retained search condition can be used to make a program search or can be changed for making a program search.

In the description given above, the invention covers reception of digital broadcasts providing multiplexed programs as MPEG-TS signal, but can also be applied to digital broadcasts such as DAB, of course.

As described above, according to the embodiments of the invention, when a digital broadcast of a program is received together with program guide information for providing a guide to the program content, it is determined whether or not the program matches a preset search condition based on the program guide information. A program search is made so as to continue to receive the digital broadcast of the program, which is determined matching the search condition, and to stop receiving the digital broadcast of the program, which is not determined matching the search condition, and receive a different digital broadcast. The received programs can be narrowed down so as to receive only the programs matching the preset search condition rather than all broadcast programs; an efficient program search can be accomplished.

According to the embodiments of the invention, if the audience inputs the condition, it is set as the search condition by the condition setting unit. Thus, the audience can rapidly find any desired program.

According to the embodiment of the invention, it is made possible for the audience to select a condition input in the condition input unit out of a provided condition list. Thus, the condition entry operation of the audience can be simplified. If the user does not know any desired service type, name, etc., the user can select appropriate condition out of the list and input the condition.

According to the embodiment of the invention, the search condition containing the specified operation such as negation NOT of the condition input by the audience in the condition input unit or OR or AND on a plurality of conditions is set and a program search is made. Thus, a program search can be efficiently made under any desired condition of the audience. Since a plurality of conditions can be combined, furthermore detailed condition specification is made possible. Since the search condition is set and a plurality of conditions can be combined, the program search efficiency is enhanced and it is made possible to immediately find any desired program.

According to the embodiments of the invention, the program genre can be specified as the search condition, and a program search can be made in accordance with the audience's wishes.

According to the embodiments of the invention, the service type of video, audio, data, or temporary contained in digital broadcast can be specified as the condition, and a program search can be made in accordance with the audience's wishes.

According to the embodiments of the invention, since a program search is made based on the set condition for each service type of video, audio, data, and temporary contained in digital broadcast, program selection can be made while a comparison is being made between the service types. If programs different in service type such as television broadcast, radio broadcast, data broadcast are presented by turns during the program search, the screen display does not provide consistency and may get in the way of finding any desired program. If a program search is made for each service type in such a manner that first a search is made for all television broadcasts and then for all radio broadcasts, the user can easily keep track of the program contents and can smoothly search for any desired program.

According to the embodiments of the invention, a keyword about at least any of the program name, cast, and program detail information can be input in the condition input unit. Thus, the audience can make more detailed condition specification of a singer name, cast, a competition team name, etc., which are not contained in a condition list, and input a keyword to select any desired program and can make a program search based on such a keyword.

According to the embodiment of the invention, if the user inputs a program trial reception request while the program search unit is executing a program search, the program search can be stopped program trial reception can be executed. Thus, if the user cannot know whether or not the program is the desired program in a given presentation time period in the program search, for example, during CM, the user can keep track of the program content by executing trial reception of the service for a while.

According to the embodiments of the invention, if program trial reception is executed during program search execution or if it becomes clear that the checked program content is not stop point. Thereby the search efficiency can be enhanced.

According to the embodiments of the invention, any retained search condition can be used to make a program search or can be changed for making a program search.

According to the embodiments of the invention, the program search can be made according to the retained search condition. Thus, if a program search is made according to the same search condition as the previous one, the condition setting history may be used to eliminate the need for again executing burdensome setting; rapid program search can be made.

What is claimed is:

1. A digital broadcast reception apparatus for receiving a digital broadcast including a program and program guide information for providing a guide to the program content, the digital broadcast reception apparatus comprising:
a broadcast reception unit for receiving a digital broadcast on air;
a condition determination unit for determining whether or not the program matches a search condition on the basis of the program guide information received by the broadcast reception unit; and
a program search unit for making a program search by controlling the broadcast reception unit
to continue to receive the digital broadcast containing the program, which is determined matching the search condition by the condition determination unit, and
to stop receiving the digital broadcast containing the program, which is not determined matching the search condition by the condition determination unit and to receive another digital broadcast.

2. The digital broadcast reception apparatus according to claim 1 further comprising:
a condition input unit for accepting an entry operation of a condition; and
a condition setting unit for setting the condition input in the condition input unit as the search condition.

3. The digital broadcast reception apparatus according to claim 2, wherein:
the condition input unit accepts an entry operation of selecting the condition from a previously prepared list including a plurality of conditions; and
the condition setting unit sets the condition, which is selected by the condition input unit accepting the entry operation, as the search condition.

4. The digital broadcast reception apparatus according to claim 2, wherein:
the condition input section accepts an entry operation of a plurality of conditions and an operation of specifying a logical operation for the conditions; and
if the user specifies the logical operation for the conditions input through the condition input unit, the condition setting unit sets the input conditions together with the specified logical operation as the search condition.

5. The digital broadcast reception apparatus according to claim 2, wherein the condition input unit accepts an operation of specifying a program genre as the condition.

6. The digital broadcast reception apparatus according to claim 2, wherein:
service types of the digital broadcast include video, audio, data, and temporary broadcast; and
the condition input unit accepts an operation of specifying at least one of the service types as the condition.

7. The digital broadcast reception apparatus according to claim 1, wherein:
service types of the digital broadcast include video, audio, data, and temporary broadcast; and
the program search unit makes the program search for each program service.

8. The digital broadcast reception apparatus according to claim 2, wherein:
the condition input unit is input into a keyword concerning at least one of a program name, cast, and program detail information; and
the condition setting unit sets the search condition to receive a program containing the keyword input into the condition input unit.

9. The digital broadcast reception apparatus according to claim 1, further comprising:
a request input unit allowing to input a program trial reception request while the program search unit is executing the program search; and
a control unit for controlling the program search unit to stop the program search and controlling the broadcast reception unit to execute program trial reception when the program trial reception request is input into the request input unit.

10. The digital broadcast reception apparatus according to 9, wherein:
the request input unit allows to input a program search restart request for stopping the program trial reception and restarting the program search; and
when the program search restart request is input into the request input unit, the control unit controls the program search unit to restart the program search at the program search stop state.

11. The digital broadcast reception apparatus according to claim 10, further comprising:
a condition retention unit for retaining the search conditions set by the condition setting unit.

12. The digital broadcast reception apparatus according to claim 11, wherein the condition determination unit determines whether or not the program matches the search condition retained in the condition retention unit.

13. A method for receiving a digital broadcast including a program and program guide information for providing a guide to the program content, the method comprising:
receiving a digital broadcast on air;
determining whether or not the program matches a search condition on the basis of the program guide information received; and
making a program search by:
continuing to receive the digital broadcast containing the program, which is determined matching the search condition; and
stopping receiving the digital broadcast containing the program, which is not determined matching the search condition and receiving another digital broadcast.
